(19) United States
(12) Patent Application Publication
(10) Pub. No.: US 2005/0230984 A1
(43) Pub. Date: Oct. 20, 2005

(54) Pine cone collection tool

(76) Inventors: Douglas Seefeldt, Corpus Christie, TX (US); Debra Seefeldt, Corpus Christie, TX (US); Milton Seefeldt, Silverton, OR (US); Jeff Bendio, Spokane, WA (US)

Correspondence Address: KEITH S BERGMAN;ATTORNEY AT LAW, 7 SOUTH HOWARD STREET, SUITE 418, SPOKANE, WA, 992013898, US

(21) Appl. No.: 10/826,629

(22) Filed: Apr. 15, 2004

(51) Int. Cl. A01D 46/00

(52) U.S. Cl. 294/19.2

(57) ABSTRACT

A collection tool that allows retrieval and collection of pine cones by a user while maintaining an erect posture. The tool provides an elongate tubular body having manipulative handles at its upper end portion and defines first connecting means at its lower end portion. The lower end portion carries an entry structure, an annular rim with second connecting means to matingly interconnect the first connecting means and carries a plurality of radially inwardly extending fingers formed of resiliently deformable material having retentent memory. Pine cones may gain ingress through the entry structure responsive to downwardly directed force thereon but are prevented from egress to be collected in the body channel for disposition.

### BACKGROUND OF INVENTION

### RELATED APPLICATIONS

There are no applications related hereto heretofore filed in this or in any foreign country by any of the instant inventors acting individually or in any combination.

1. Field of Invention

This invention relates generally to receptacles with means to gather and store a product and more particularly to a tubular receptacle having a resiliently deformable entry structure at its lower end to allow ingress of pine cones therethrough and prevent egress therefrom.

2. Background and Description of Prior Art

Coniferous trees of the order Coniferales are widely distributed especially through the temperate zones of the earth and such plants are often used for ornamentation and landscaping in cultivated habitable areas. These plants in their ordinary life cycle drop cones during a substantial portion of each calendar year and in general it is desired that these cones be collected and removed from cultivated areas both by reason of the aesthetics involved and the impediments that such cones present to future cultivation if they remain in place. In general in smaller areas such cones heretofore have been collected for removal by direct manual means of collection with the collector's hands or sometimes as aided by hand tools such as a rake to bring a plurality of such cones into a collection area where the plurality may be picked up individually by hand or moved into some type a container. In larger areas fallen pine cones have sometimes been collected by use of mechanical devices such a mechanized rakes, rotary brushes or the like. Such mechanized devices, however, are sufficiently costly to make them economically infeasible for the owners of smaller parcels of property and oftentimes such mechanisms are not operative within the physical bounds and obstacles of smaller parcels of property or over topographic features oftentimes present in such parcels.

The instant invention provides a hand manipulable tool, of simple and economic construction for use in picking up and storing a plurality of fallen pine cones, that may be operated by a user while maintaining a standing position and without direct manual contact with the pine cones.

Pine cones comprise a plurality of ovule-bearing or pollen-bearing scales or bracts in trees of the pine family (genus Pinus of the Pinaceae family) or in cycads (family cycadacene). The size and configuration of pine cones vary widely with major dimensions ranging upwardly to twelve inches or more and minor dimensions, especially in smaller cones, often approaching the major dimensions to produce configurations ranging from a near spherical-like shape ranging through oblate spheroids and elongate curvilinear conics. Pine cones also vary widely in their density and both the density and configuration of cones commonly changes through different periods of their life cycle, whether attached to a tree or having fallen therefrom. For a tool to be useful in collecting pine cones and have any economic viability for use in the United States it must be usable with a wide variety of cones of varying dimensions and configurations there present.

The scales and bracts of pine cones are commonly quite hard and rigid when and after the cones have dropped and the configuration of many bracteal types is somewhat triangular with the apex of the triangle extending outwardly and terminating in a sharp thorn-like end. By reason of this structure it is desirable that a tool for pine cone collection operate in a fashion that does not require direct manual contact or manipulation of the cone by a user to prevent injury and discomfort.

It is further desirable in a pine cone collecting tool that the tool provide a containment structure wherein a plurality of collected pine cones may be accumulated and stored before having to empty the tool for reuse. For practical usability the containment chamber must also be easily accessible and manipulable to allow the emptying of stored pine cones again preferably without any manual contact by a user.

Heretofore various hand tools designed and used primarily for purposes other than the collection of pine cones have been used for pine cone collection, but it is not known that any tools heretofore known have been specially designed for pine cone collection. Long handled tools of a grasping type having jaws pivotally movable toward and away from each other have been used for pine cone collection but those tools do not necessarily well grasp a pine cone, are not easily manipulable to so do and do not provide any means for storing a plurality of collected pine cones for deposition at a future time. Various sweeping or raking type hand tools have been used to amass a plurality of pine cones for collection but these tools again provide no storage facility for collected cones, require the use of some separable auxiliary storage member and often require the user to move from a standing position to place the amassed cones in a storage member. Various tube or chamber type devices having an orifice structure that passes objects only for ingress and prevent egress of contained objects have heretofore been known, but in general such devices have been designed for specific objects generally having uniform predetermined size and configurations such as collection devices for golf balls, tennis balls, baseballs and the like. These devices have often allowed operation without a user moving from a standing posture but they are not usefully operable to pick up pine cones of substantially varying shapes and sizes as such devices generally have no means for picking up variously configured objects such as pine cones. If pine cones should pass into their storage elements there is no means to surely prevent their egress.

The instant invention seeks to resolve these problems by providing an elongate tubular tool with a particular entry structure about its lower orifice providing a releasably attachable annulus supporting a plurality of radially inwardly extending circumferentially spaced finger elements that are formed of resiliently deformable sheet material that has a retentent memory that operates quite rapidly to return the finger structures to a normal null configuration after deformation. The finger structures may have a slightly arcuate axially inward curvature which aids in maintaining a pine cone beneath the entry structure. Both any curvature of the entry structure and the peripheral shape of the split finger elements operate synergistically during the collecting process to move a pine cone into a position relative to the entry structure that provides a much higher probability of entry of the pine cone through the entry structure and its retention in the tool than entry and retaining structures of devices used to collect objects of predetermined standardized size and configuration.

Our invention does not reside in any one of the aforesaid features individually but rather in the synergistic combination of all of the structures of our tool that necessarily give rise to the functions flowing therefrom as hereinafter specified and claimed.

### SUMMARY OF INVENTION

Our tool in general provides a rigid cylindrically tubular body having a first upper end and second spacedly adjacent lower end defining first fastening means. The upper portion of the body spacedly below its upper orifice preferably carries one or more manipulating handles to aid manual manipulation and carriage of the tool. The second lower end portion of the body carries an entry structure comprising a cap-like member having an annular peripheral rim defining second connecting means to releasably interconnect the entry structure with the first connecting means of the lower end portion of the body. The peripheral rim structurally carries preferably three radially inwardly extending split finger elements that extend inwardly to a point spacedly adjacent the axis of the peripheral rim to leave a void about the inner end portions of the fingers that communicate with voids between the fingers. The finger elements are formed of resiliently deformable sheet material having a retentent memory that is operative within a relatively short period of time such as various of the polymeric or resinous plastic of modern day commerce.

In operation the assembled tool in vertical orientation is positioned over a pine cone to be collected with the pine cone immediately beneath the lower surface of the entry structure. Force is applied by a user to move the tool downwardly upon the subject cone. As this occurs the entry structure fingers will deform upwardly toward the tool body to cause the subject cone to pass upwardly into the tool body channel. Upon such passage the fingers will then assume their previously existing null mode by reason of their retentent memory. A plurality of pine cones may be collected in similar fashion and will displace previously collected cones upwardly within the chamber defined by the body to ultimately allow dumping through the open upper end of the body by appropriate manipulation by a user.

In providing such a device it is:
a principal object is to provide a pine cone collecting tool specifically designed for that purpose to allow collection of pine cones of a wide ranging sizes and shapes.

A further object is to provide such a tool with an elongate tubular body of substantial length such that the tool may be manipulated manually by a user to collect pine cones while remaining in a standing posture.

A further object is to provide such a tool having an open upper channel orifice that permits simple and easy dumping of pine cones contained in the body channel by tipping the tool with its normally upper end downwardly over a desired deposition site to allow removal of contained cones by action of gravity.

A further object is to provide such a tool having a releasably carried entry structure at the lower end of the body that partially covers the lower entrance of the body to allow ingress of pine cones through the entry structure and into the body but prevents egress of cones carried in the body channel back through the entry structure.

A still further object is to provide such entry structure having a peripheral annulus with preferably three or four circumferentially spaced split fingers extending radially inwardly therefrom to positions spacedly adjacent from each other to define a central void between finger ends communicating with voids between each adjacent pair of the fingers.

A further object is to form such finger structures of resiliently deformable sheet material having retentent memory so that the fingers may be deformed to allow ingress of pine cones therethrough and into the body channel by reason of resilient deformation but prevent egress of cones from the body channel by reason of retentent memory.

A still further object is to provide such an entry structure wherein the resilient fingers may be angulated axially inward relative to the tubular body to aid in positioning and maintaining a pine cone beneath the entry structure.

A still further object is to provide such a tool that is of new and novel design, of rugged and durable nature, of simple and economic manufacture and one that is otherwise well suited to the uses and purposes for which it is intended.

Other and further objects of our invention will appear from the following specification and accompanying drawings which form a part hereof. In carrying out the objects of the invention, however, it is be understood that its features are susceptible to change in design and structural arrangement with only one preferred and practical embodiment being illustrated in the accompanying drawings as is required.

### DESCRIPTION OF DRAWINGS

In the accompanying drawings which form a part hereof and wherein like numbers of reference refer to similar parts throughout:

FIG. 1 is an orthographic front and right side view of our cone collecting tool.

FIG. 2 is an expanded and partially cutaway orthographic front elevational view of the tool of FIG. 1.

FIG. 3 is an enlarged isometric view of one of the manipulating handles of the tool of FIG. 1.

FIG. 4 is a medial cross-sectional view of the handle of FIG. 3, taken on the line 4-4 thereon in the direction indicated by the arrows.

FIG. 5 is an isometric view of the entry structure of the tool of FIG. 1, taken from the inside looking in an outward direction.

FIG. 6 is an isometric view of the entry structure of the tool of FIG. 1 looking inwardly toward the tool body.

FIG. 7 is an enlarged orthographic bottom view of the entry structure of FIG. 6.

FIG. 8 is a diametrical cross-sectional view to the entry structure of FIG. 7, taken on the line 8-8 thereon in the direction indicated by the arrows.

### DESCRIPTION OF THE PREFERRED EMBODIMENT

Our pine cone collecting tool in general comprises elongate tubular body 10 carrying at least one manipulating handle 11 axially inwardly from its upper end and releasably carrying cap-like entry structure 12 at its lower end.

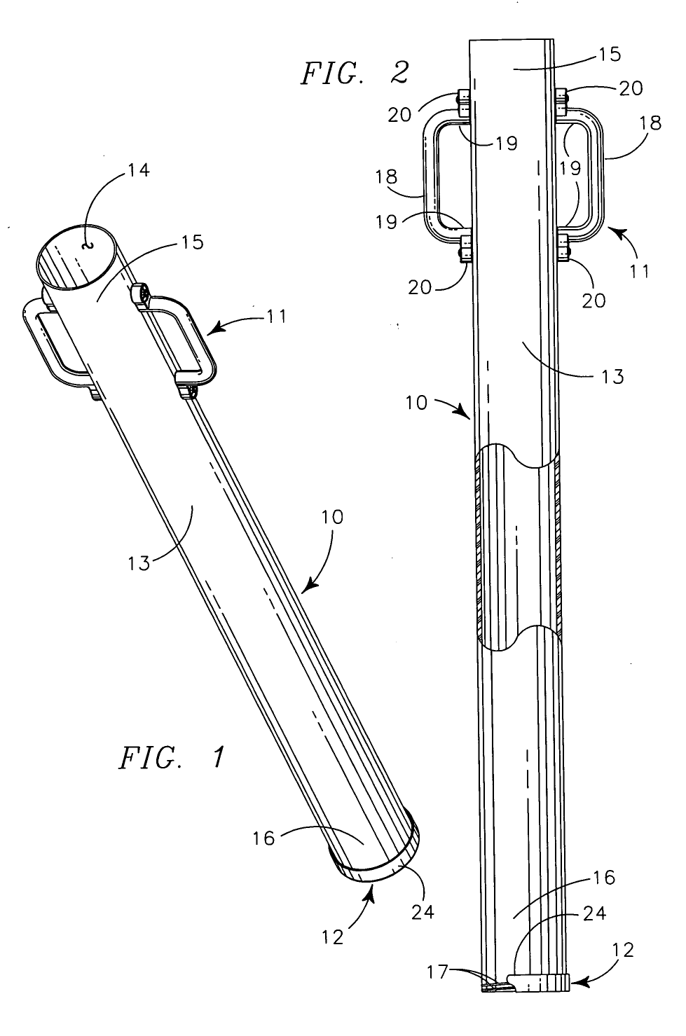

Body 10 provides elongate right circular cylindrical tube 13 defining medial channel 14 extending from upper end portion 15 to lower end portion 16. The lower end portion 16 of tube 13 defines fastening means 17 in the instance illustrated in FIG. 2 comprising external threads to cooperate with fastening means defined by entry structure 12 to positionally maintain the entry structure 12 on the lower end portion of cylindrical body tube 13, preferably in a releasable type interconnection.

Cylindrical tube 13 is formed of some rigid durable material that is of light weight to aid manipulation of the tool, preferably such as polymeric or resinous plastic. For use with a maximum number of pine cones of conifers prevalent in the United States the cylindrical tube 13 should have a relatively thin circumferential wall with an external diameter of approximately five inches and a length varying from approximately thirty-six to forty-eight inches. This preferred configuration is not essential to the operability of the tool and may vary to accommodate particular conditions of use and physical characteristics of users.

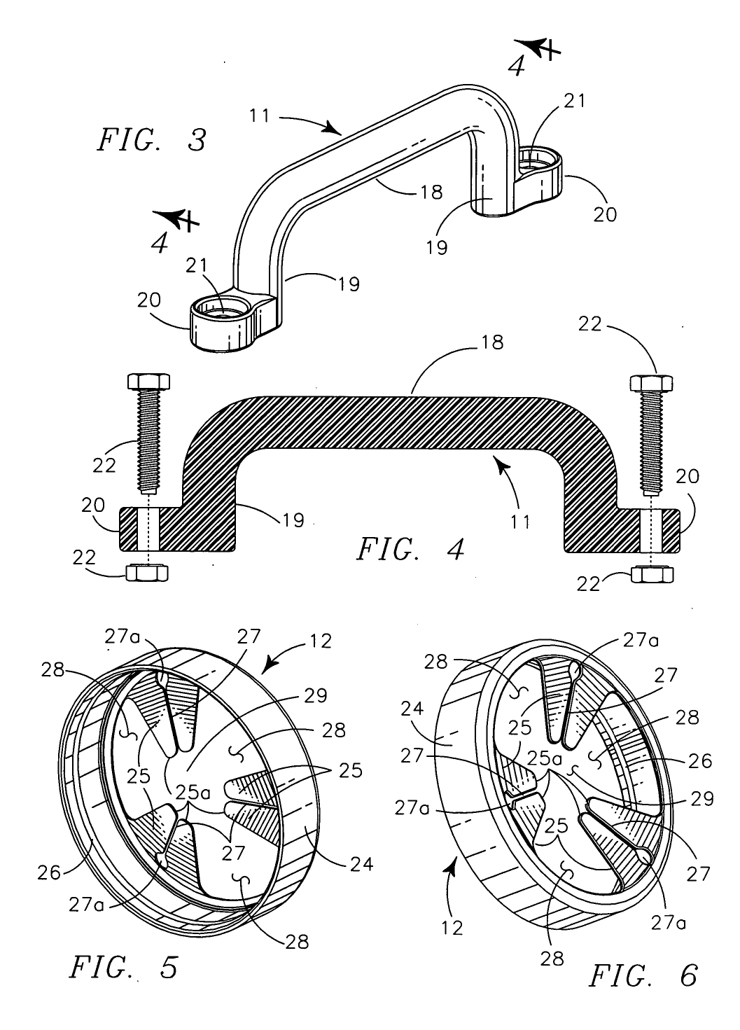

Manipulating handles 11 as illustrated in FIGS. 3 and 4 are two in number and of a common U-shaped type. The handles 11 provide grasping back 18 perpendicularly projecting legs 19 each having fastening brackets 20 extending perpendicularly from the outer end portion of each leg 19. In the instance illustrated each fastening bracket defines medial hole 21 to receive nut/bolt fastener 22 therethrough to attach the handles to cylindrical tube 13. Spacedly opposed pairs of fastening holes (not shown) are defined in cylindrical tube 13 inwardly adjacent upper end portion 15 of cylindrical tube 13 with the same spacing as holes 21 in fastening brackets 20 of the manipulating handles 11 to releasably fasten those handles in vertical orientation and diametrically opposed positions on the upper portion 15 of cylindrical tube 13, as illustrated in FIGS. 1 and 2.

The particular manipulating handle structures illustrated are not essential to the operation of our tool but do make tool operation and manipulation more easy. Various other known types of handles may be substituted for use with the tool and the handles may have varying orientation and positioning in the upper part of the tool. The tool is operative without any handle structures at all but in that configuration the tool may not be as easily manipulated and used as in a configuration providing handles. Entry structure 12 is a cap-like member formed by circularly annular peripheral rim 24 structurally carrying radially inwardly extending fingers 25. The inner surface of rim 24 has a diameter slighter greater than the outer diameter of cylindrical tube 13 so that the rim may fit over and about the lower end portion 16 of the cylinder 13 to allow fastening without narrowing the internal diameter of medial channel 14 of the cylindrical tube 13. The upper inner surface of rim 24 defines fastening means 26, in the instance illustrated comprising threads, to releasably fastenably interconnect with fastening means 17 defined by lower end portion 16 of cylindrical tube 13.

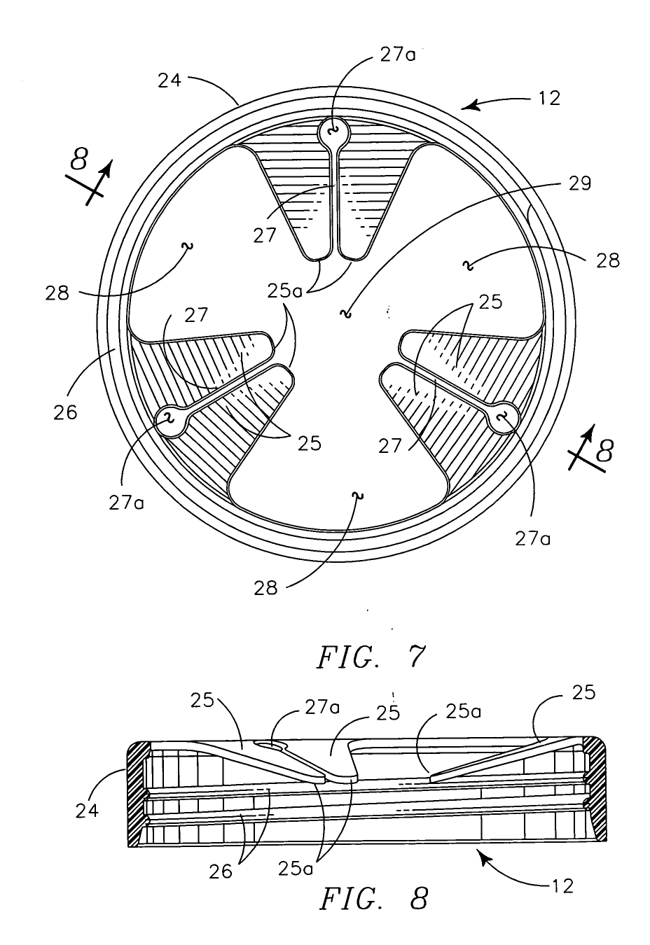

Fingers 25 in the instance illustrated in FIGS. 7 and 8 are three in number and of a somewhat truncated triangular configuration with corners and edges filleted. Each finger 25 is equally spaced about the inner periphery of rim 24 and is structurally supported thereby. Structural support may be created by reason of unitary formation of the fingers and rim or known structural joinder methods. If desired, the fingers may be joined by a separate finger rim (not shown) so that they may be removably attached to rim 24 to allow replacement if desired.

Each finger defines a radially oriented medial slot 27 and this slot in its radially outer end portion terminates in bulbous enlargement 27a to allow more flexibility of each opposed portion of the fingers 25 and prevent breakage and cracking of the finger material in its radially outer portion. The fingers 25 are configured and circumferentially spaced about rim 24 such that the circumferential space between fingers is at least equal to or greater than the circumferential space occupied by the base of each finger 25 at the point of its attachment to rim 24 to create somewhat angularly shaped spaces 28 between each finger. The radially extension of inner end portions 25a of each finger is spacedly distant from the center of rim 24 to create a medial space 29 between inner ends of fingers of 25a. With this structure then the spaces 28 between fingers 25 and the medial space 29 between the end portions 25a of the fingers join with each other to form a clover leaf type orifice 28,29 within the inner periphery of rim 24.

The fingers 25 may be coplanar in a plane that is perpendicular to the axis of rim 24 and body 10 or the fingers 25 may be somewhat angulated in a direction toward body 10 when rim 24 is in position thereon, as shown in the cross-sectional view of FIG. 8. If fingers 25 are angulated, this creates an indentation in the medial portion of the entry structure which makes it easier for a user to center a pine cone to be operated upon beneath the orifice 28,29 and may also make it easier to manipulate the tool to cause a pine cone to enter through the orifice 28, 29. If the fingers 25 are angulated the angulation may not be too great, preferably not more than ten to fifteen degrees, or the angulation may hinder the operation of the tool in picking up a pine cone beneath the entry structure by causing downward force on body 10 as hereafter described.

Fingers 25 must be formed of some resiliently deformable material having a retentent memory such as to be operative in a reasonably short period of time to return the fingers 25 to their null mode after deformation. The material of preference is a polymeric or resinous plastic in the form sheet material that may be configured as hereinbefore specified. Common plastics such as polyethylene, polypropylene and polyurethane are suitable to fulfill this purpose. The configuration of the fingers 25, both as to periphery and thickness, may have to be somewhat regulated to a particular plastic to produce the desired functions of the entry structure 12. It is possible that the fingers 25 could be formed from quite thin sheet metal of high elasticity, such as stainless steel and that material is within the ambit and scope of our invention though it has not been found to be as useful and practical as polymeric material.

Having described the structure of our cone collecting tool its use may be understood.

A tool is formed according the foregoing specification and manually moved to the location of a pine cone to be collected. The tool is placed with the entry structure 12 resting on and immediately above the subject cone. The tool then is grasped by manipulating handles 11 and forced downwardly until the lower edge of annular peripheral rim 24 rests on the surface supporting the subject pine cone. As the entry structure 12 moves downwardly relative to the pine cone therebeneath, portions of the fingers 25 will be deformed by the pine cone and the cone will ultimately pass through the orifice defined by spaces 28,29, move into the medial channel 14 of body tube 13. As the cone moves through the entry structure 12 the fingers 25 of entry structure 12 by reason of retentent memory, will return to their null state that existed before deformation and the tool will be ready for a second similar pine cone collecting operation as described.

The collected cone in medial channel 14 of the cylindrical tube 13 will be retained within the tube 13 because there is no external force in the body channel 14 upon the cone to allow it to deform fingers 25 to move outwardly therepast and the force of gravity acting upon the cone and any other cones in the body channel 14 is not sufficient to cause such action.

The cone collecting process then is continued in a similar fashion until a quantity of cones is carried within medial channel 14 of the body 10. At this point when the collecting operation has been completed or the body 10 reasonably filled with pine cones, the tool is manually moved to a disposition sight spacedly above the area where cones are to be deposited. The tool is manually manipulated to turn it upside-down and the pine cones carried in medial channel 14 of the body 10 will move by action of gravity outwardly from the open upper end portion 15 of body 10 and be deposited somewhat vertically therebelow.

In using the instant tool it is to be noted that both the tool and a pine cone to be collected thereby may easily be moved relative to each other to better position a pine cone in a loading position or to better accomplish the passage of the pine cone through the entry structure 12 and into the tool body 10. This movement, the entire loading operation and unloading operation may be accomplished by the user while in a standing position and without any manual contact with the pine cones in the entire collection and disposition process.

The foregoing description of our invention is necessarily of a detailed nature so that a specific embodiment of its best known mode might be set forth as required, but it is to be understood that various modifications of detail, rearrangement and multiplication of parts might be resorted to without departing from its spirit, essence or scope.

Having thusly described our invention, what we desire to protect by letters patent and

1. A pine cone collecting and holding tool comprising in combination:
an elongate tubular body defining a medial channel and having an upper end portion opening to said medial channel and a lower end portion opening to said medial channel and defining first fastening means and;
an entry structure having an annular peripheral rim defining an orifice geometrically similar to and larger than the lower end portion of the tubular body to fit over the lower portion of the tubular body, said peripheral rim;
defining second fastening means to releasably interconnect with the first fastening means of the body for positional maintenance of the peripheral rim on the body, and
a at least two of resiliently deformable triangular-like fingers spacedly carried about the inner surface of the rim to extend radially inwardly spacedly distant from each other to define an orifice between the fingers to allow passage of pine cones therethrough upon deformation of at least one of said fingers responsive to force exerted upon the at least two of said fingers by the pine cones.

2. The tool of claim 1 wherein the body and the peripheral rim have circularly cylindrical configurations.

3. The tool of claim 1 further having
at least one manipulating handle extending radially outwardly from structural interconnection with the body spacedly inwardly from the upper end portion thereof.

4. The tool of claim 3 further characterized by the at least one manipulating handle having a U-shaped body with similar opposed parallel legs extending perpendicularly from each end thereof, said legs carrying perpendicularly extending fastening brackets having means for fastening to the tool body.

5. The tool of claim 1 wherein the plurality of fingers of the entry structure are coplanar.

6. The tool of claim 1 wherein at least one of the plurality of fingers is angulated in a radially inward direction toward the tool body and at an angle of not more than about twenty degrees to a plane parallel to the peripheral rim.

7. The tool of claim 1 wherein each of the fingers defines a medial radially extending slot terminating in its radially outer portion in a bulbous enlargement to allow the radially inner portions of each finger to move substantially independently of each other.

8. The tool of claim 1 formed of one of the plastics of the group containing polyethylene, polyurethane and polypropylene.

9. The tool of claim 1 wherein the first fastening means carried by the lower end portion of the body comprise external threads and the second fastening means carried by the inner surface of the rim of the entry structure comprises internal threads that matingly enmesh to releasably interconnect the body and the entry structure.

10. The tool of claim 1 wherein the diameter of the medial channel of the body is approximately two to twelve inches and the axial length of the body is approximately twenty-four to forty-eight inches.

11. A pine cone collecting and holding tool comprising in combination:
an elongately circularly cylindrical tubular body having a medial channel, an axial length of between twenty-four and forty-eight inches and a diameter of between four and ten inches, said body
having an upper end portion opening to the medial channel and a lower end portion defining first fastening means about an orifice opening to the medial channel;
at least two U-shaped manipulating handles carried in diametrically opposed positions on the body spacedly downwardly from the upper end portion; and
entry structure at the lower end portion of the body having
an annular peripheral rim with an internal diameter larger than the external diameter of the lower portion of the body to fit thereover, said annular rim defining second fastening means on its inner surface to matingly fasten with the first fastening means defined in the lower portion of the body,
a plurality of circumferentially spaced triangular-like fingers carried by the peripheral rim to extend radially inwardly to a position spacedly distant from the inner portions of each other finger, each of said fingers formed of resiliently deformable material having retentent memory and defining a medial slot extending radially outwardly from the inner end portions of the fingers to terminate in a bulbous enlargement to allow the radially inner end portions of each finger to move relative to each other.
